(19) United States
(12) Patent Application Publication
(10) Pub. No.: US 2016/0185303 A1
(43) Pub. Date: Jun. 30, 2016

(54) CARGO CARRIER ATTACHABLE TO A TRAILER HITCH

(71) Applicants: Randall Oxley, Swisher, IA (US); Neal L. Oxley, Des Moines, IA (US)

(72) Inventors: Randall Oxley, Swisher, IA (US); Neal L. Oxley, Des Moines, IA (US)

(21) Appl. No.: 14/980,500

(22) Filed: Dec. 28, 2015

Related U.S. Application Data
(60) Provisional application No. 62/097,301, filed on Dec. 29, 2014.

(51) Int. Cl. B60R 9/06

(52) U.S. Cl. CPC B60R 9/06

(57) ABSTRACT

A cargo carrier for attachment to a trailer hitch can be manipulated from a folded position to a plurality of load carrying positions. The cargo carrier has several extension members and telescoping members that can be utilized in a variety of positions to accommodate a particular load.

### CROSS-REFERENCE TO RELATED APPLICATIONS

The present application claims priority to provisional patent application 62/097,301 which was filed on Dec. 29, 2014, and is hereby expressly incorporated by reference in its entirety.

### BACKGROUND

There are several cargo carriers on the current market that can be attached to a rear of a vehicle typically utilizing a trailer hitch. The cargo carriers can be bulky and are not easily stored or transported when not attached to a vehicle. Furthermore, the cargo carriers cannot be easily adapted to fit different shapes and types of objects being transported.

Therefore, it is an object of the invention to provide a cargo carrier that can be easily transported by a user without a vehicle.

It is a further object of the invention to provide a cargo carrier that can form a plurality of different shapes to transport a variety of objects.

### SUMMARY OF THE INVENTION

This present invention is a cargo carrier that provides a solution to the problems of being unable to transport certain objects due to the limitations of a particular vehicle and/or the limitations of the current state of art of cargo carriers. Additionally, the cargo carrier is easily portable while in a folded position. The cargo carrier is selectively attachable to a trailer hitch in either the folded position or a cargo carrying position.

The invention utilizes several elongated members and linkages to achieve a plurality of positions to accommodate a variety of objects such as canoes, lumber, poles, etc.

### BRIEF DESCRIPTION OF THE DRAWINGS

FIG. 1 is a perspective view of the cargo carrier in a folded position;

FIG. 2 is a perspective view of the cargo carrier in a load carrying position;

FIG. 3 is a side view of the cargo carrier in a second load carrying position;

FIG. 4 is a front view of the cargo carrier in the second load carrying position;

FIG. 5 is a side view of the cargo carrier in a third load carrying position;

FIG. 6 is a perspective view of the cargo carrier in the folded position attached to a trailer hitch.

### DETAILED DESCRIPTION

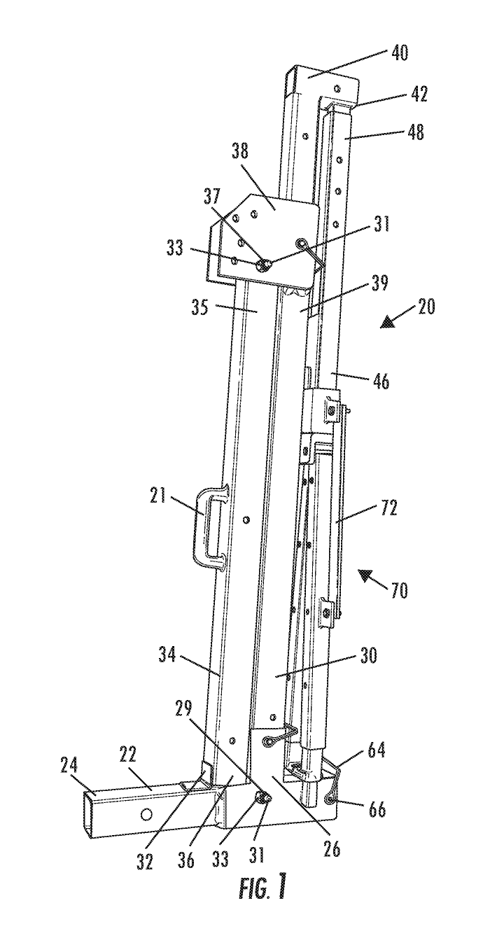

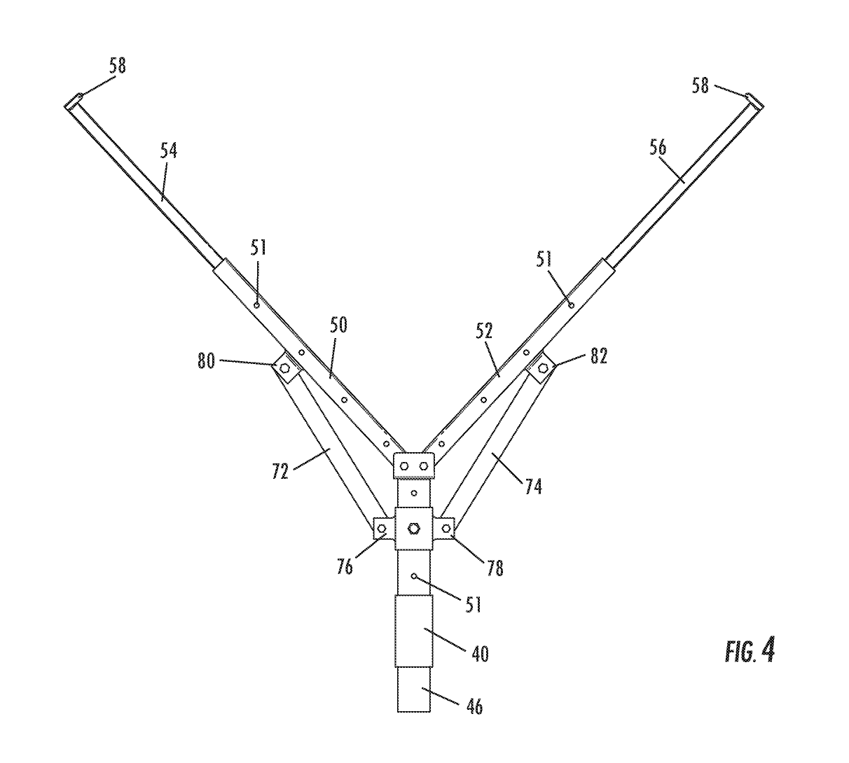

FIGS. 1-6 depict a cargo carrier 20 attachable to a vehicle in either a folded position or in one of several load carrying positions. The cargo carrier 20 allows a vehicle to transport objects that cannot be accommodated by the vehicle to the size limitations of the vehicle.

Although the cargo carrier includes the same parts in the folded and load carrying positions, the arrangement of the parts in the folded position is described first. FIG. 1 shows the cargo carrier 20 in a folded position that can easily be carried by a user of the cargo carrier 20 by utilization of a handle 21.

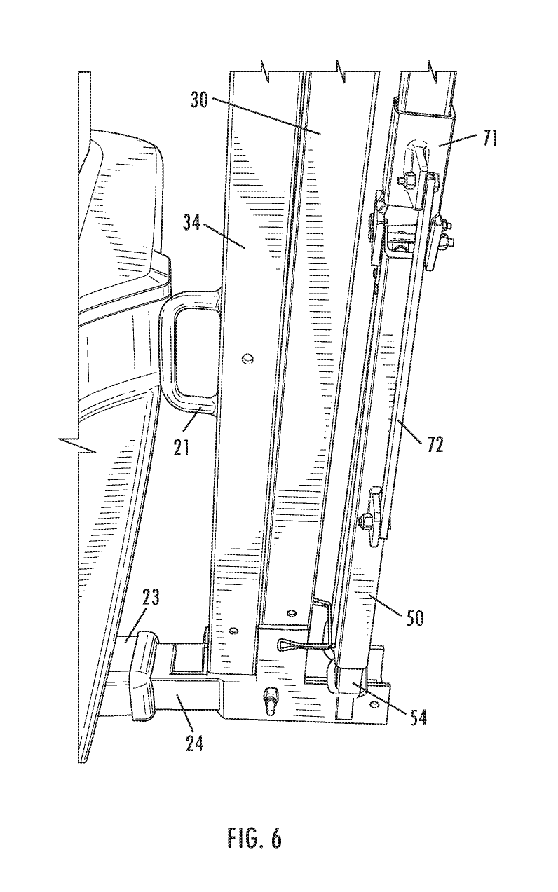

The cargo carrier 20 comprises a first end 22 which can be attached to a trailer hitch 23 (shown in FIG. 6) of a vehicle. A trailer linkage 24 includes flanges 26 and 28. While in the folded position, a first extension member 30 is placed between the flanges 26, 28 and secured by a securing mechanism 29, preferably a screw 31 and nut 33. A third flange 32 is perpendicular to flanges 26 and 28. A second extension member 34 is placed on top of the first extension member 30 such that the third flange 32 helps secure a first end 36 of the second extension member 34.

The first extension member 30 and the second extension member 34 are preferably made of metal and are hollow to make the cargo carrier lightweight. A first linkage member 38 is at a second end 39 of the first extension member 30. The first linkage member 38 is preferably welded to the first extension member 30. A second end 35 of the second extension member 34 is attached to the linkage member 38 by use of an attachment mechanism 37. Preferably, the attachment mechanism 37 is a nut 33 and bolt 31.

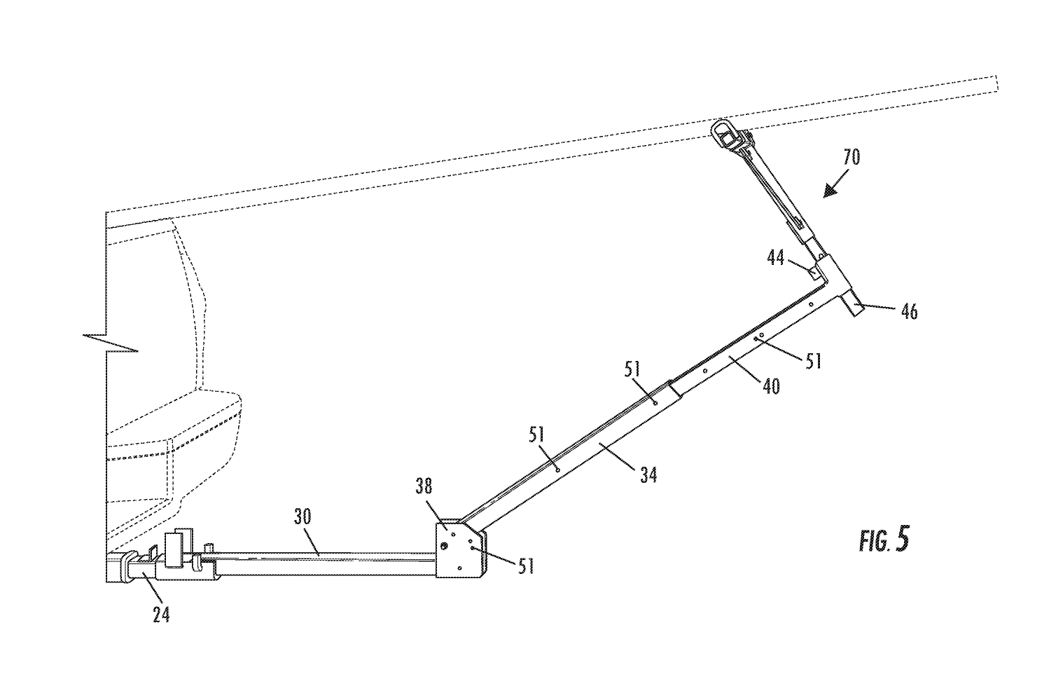

A second linkage member 40 is shaped and sized such that it can fit within the first extension member 30 or the second extension member 34. In FIG. 1, the second linkage member 40 is substantially within the first extension member 30. A first end 42 of the second linkage member 40 has a flange 44 (shown in FIG. 5) which in the folded position is utilized to assist in maintaining a position of a third extension member 46. A first end 48 of the third extension member 46 is placed over the flange 44.

A first beam 50 and a second beam 52 are attached to the third extension member 46, again preferably with a nut 33 and bolt 31. The first beam 50 and second beam 52 are preferably hollow and house a first telescoping member 54 and a second telescoping member 56. Each of the telescoping members 54, 56 have a flange 58 at a terminal end 60, 62. Preferably the flange 58 is perpendicular to a longitudinal axis of the telescoping members 54, 56. In the folded position, the flanges 58 make contact with the trailer linkage 24 which aid in maintaining the position of the telescoping members 54, 56 while in the folded position. Additionally, a bracket 64 and pin 66 are used to assist in maintaining the telescoping members 54, 56 in the folded position.

A slidable support system 70 is mounted on the third extension member 46. A first support member 72 and a second support member 74 are attached to flanges 76, 78 respectively of the support system 70. The support members 72, 74 are also attached to the first beam 50 and second beam 52 respectively.

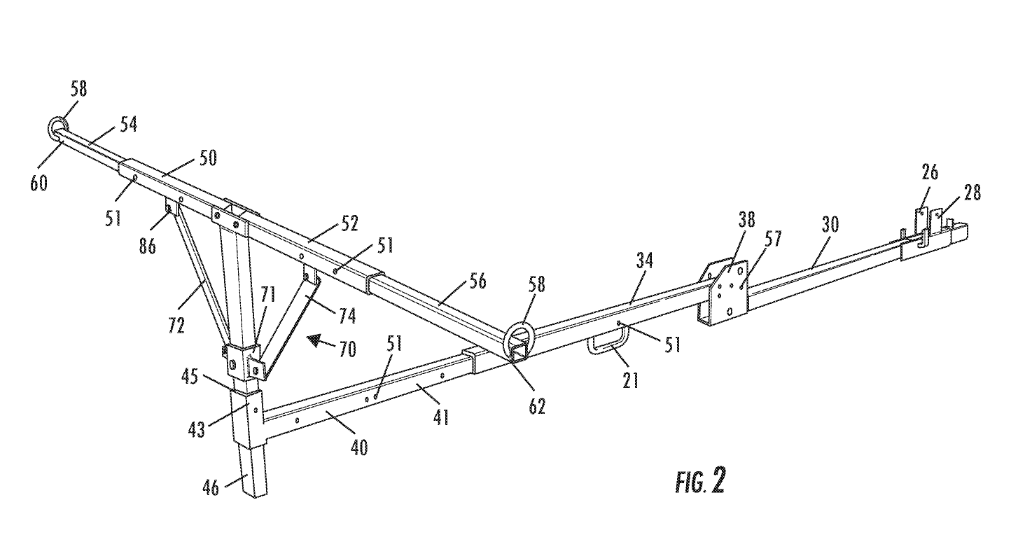

The cargo carrier 20 can be transformed from the folded position into a plurality of load carrying positions by manipulating the various parts. FIG. 2 demonstrates one such load carrying position. The following description describes how to transform the cargo carrier 20 from the folded position to achieve the position in FIG. 2. The second extension member 34 is removed and placed aside. The third extension member 46 along with the support system 70 and the beams 50, 52 are removed and placed aside. The trailer linkage 24 is secured to a trailer hitch of a vehicle.

The first extension member 30 is rotated ninety degrees such that it will be substantially parallel with a road surface. The second extension member 34 is attached to the first linkage member 38 by using a nut 33 and bolt 31 wherein the bolt is inserted through one of several openings 51 in the second extension member 34 and then through one of the openings 51 on the first linkage member 38. The exact opening that is used will determine the relative angle between the first extension member 30 and the second extension member 34.

The second linkage member 40 has a first section 41 and a second section 43 and is preferably L-shaped. The first section 41 is sized such that it can be housed within the second extension member 34. The portion of the second linkage member 40 housed within the second extension member 34 can be adjusted by using different openings 51 on the second linkage member 40. As an example, a bolt or pin can be inserted through openings in the second extension member 34 and a particular opening on the second linkage member 40. The third extension member 46 is then inserted through a cavity 45 in the second section 43 of the second linkage member 40. Similar to the process above, utilizing a particular opening along with a bolt or pin can control the height of the third extension member 46 relative to the second section 43.

The slidable support system 70 comprises a main body 71 with the two flanges 76, 78. The support members 72, 74 attach to the flanges 76, 78 and then can be connected to flanges 80, 82 on the first beam 50 and second beam 52. Similar to the second linkage member 40 being housed within the second extension member 34, the first telescoping member 54 can be housed in the first beam 50, and the second telescoping member 56 can be housed in the second beam 52. Again the portion of the first telescoping member 54 that protrudes from the first beam 50 depends on the openings 51 used on the first beam 50. A pushable protrusion slides across an inner surface of the first beam 50 until it comes to one of the openings on the first beam 50. The protrusion is sized such that it will protrude through that particular opening which corresponds to a particular exposed length of the first telescoping member 54. In order to lengthen the portion protruding, a user simply pushes the protrusion and manipulates the telescoping member in a first direction until the protrusion sticks out of the next opening. The same process is also utilized for the second beam 52 and the second telescoping member 56.

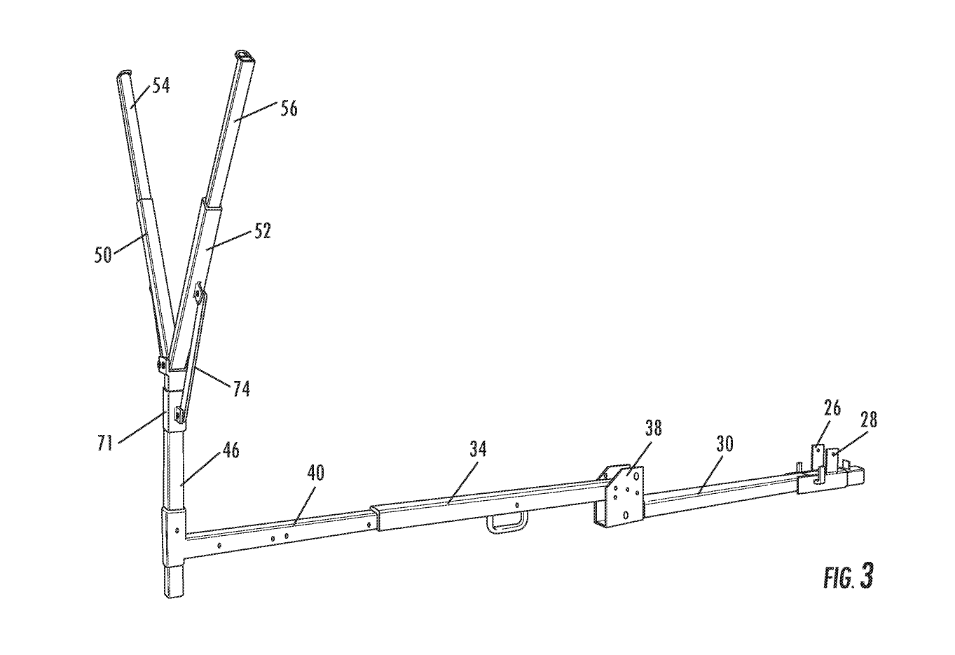

The slidable support system 70 can be slid vertically upon the third extension member 46. Again by utilizing a bolt or pin, the distance of the main body 71 relative to the first beam 50 and second beam 52 can be modified. This is best seen in contrasting FIG. 2 to FIG. 3. Utilizing an opening 51 on the third extension member 46 that is closer to the first beam 50 and second beam 52 causes the first beam 50 and second beam 52 to come closer to one another as shown in FIG. 3. Once you determine what opening 51 is best for the particular load to be carried, a bolt or pin is inserted through the third extension member 46 and the slidable support system 70 main body 71. A nut 33 or some other securing part can be used to maintain the position.

One of ordinary skill can see that by changing the positions of one or more of the parts listed above by utilizing different openings, a user can create one of numerous configurations for the load carrying position desired. Reflector tape can be used on the different members to reflect headlights of approaching vehicles. After using the cargo carrier 20 in a load carrying position, it can be folded back into the folded position shown in FIGS. 1 and 6 or modified to a different load carrying position.

While the present invention has been particularly shown and described with reference to exemplary embodiments thereof, it should be understood by those of ordinary skill in the art that various changes, substitutions and alterations can be made herein without departing from the scope of the invention as defined by appended claims and their equivalents. The invention can be better understood by reference to the following claims. For purpose of claim interpretation, the transitional phrases “including” and “having” are intended to be synonymous with the transitional phrase “comprising”.

What is claimed is:

1. A cargo carrier attachable to a vehicle having a hitch, comprising:
a hitch linkage;
a first linkage member;
a first extension member;
a second extension member;
wherein the members are selectively attachable to one another in a plurality of positions to form a plurality of formations.

2. The cargo carrier of claim 1, wherein:
a second linkage member attachable to the second extension member.

3. The cargo carrier of claim 2, wherein:
a third extension member attachable to the second linkage member.

4. The cargo carrier of claim 3, wherein:
a slidable support system on the third extension member.

5. The cargo carrier of claim 4, wherein:
the support system comprises a first support member and a second support member;
the first support member having a first end and a second end;
the second support member having a first end and a second end;
the first end of the first support member attached to the third extension member;
the second end of the first support member attached to a first beam.

6. The cargo carrier of claim 5, wherein:
the second support member is attached to the third extension member;
the second support member is attached to a second beam.

7. The cargo carrier of claim 6, wherein:
the first beam is attached to a first telescoping member.

8. The cargo carrier of claim 7, wherein:
the second beam is attached to a second telescoping member.

9. The cargo carrier of claim 8, further comprising:
a handle;
wherein the handle can be used to carry the cargo carrier.

10. The cargo carrier of claim 9, further comprising:
a plurality of openings;
attachment mechanisms;
wherein the attachment mechanisms are selectively insertable into selected openings to allow the cargo carrier to achieve a particular position.

11. A cargo carrier with the ability to transform from a folded position to a load carrying position attachable to a vehicle having a hitch, comprising:
a first linkage member;
a first extension member;
a second extension member;
wherein the first extension member is directly below or above the second extension member and the first extension member and second extension member are parallel to one another in the folded position;
wherein the first extension member is not directly above or below the second extension member in the load carrying position.

12. The cargo carrier of claim 11, further comprising:
a second linkage member;
a third extension member.

13. The cargo carrier of claim 12, wherein:
the third extension member is below the first extension member and parallel to the first extension member in the folded position.

14. The cargo carrier of claim 13, further comprising:
a handle;
the handle attached to the second extension member.

15. The cargo carrier of claim 14, further wherein:
a portion of the second linkage member is housable within the second extension member.

16. The cargo carrier of claim 15, further comprising:
a first telescoping member;
a second telescoping member;
wherein the first and second telescoping member are under the second extension member in the folded position.

17. The cargo carrier of claim 16, wherein:
a plurality of pins and brackets are utilized to maintain the folded position.

18. The cargo carrier of claim 17, further comprising:
a slidable support system on the third extension member.

19. The cargo carrier of claim 18, wherein:
the slidable support system comprises a first and second beam.

20. A cargo carrier attachable to a vehicle, comprising:
a hitch linkage;
a first linkage member;
a first extension member;
a second extension member;
a second linkage member;
a third extension member attachable to the second linkage member;
a slidable support system on the third extension member;
the support system comprises a first support member and a second support member;
the first support member having a first end and a second end;
the second support member having a first end and a second end;
the first end of the first support member attached to the third extension member;
the second end of the first support member attached to a first beam;
a plurality of openings;
pins;
wherein the pins are selectively insertable into selected openings to allow the cargo carrier to achieve a particular position for transporting various items;
wherein the first extension member is directly below or above the second extension member and the first extension member and second extension member are parallel to one another when the cargo carrier is in a folded position;
wherein the first extension member is not directly above or below the second extension member when the cargo carrier is in a load carrying position.
